(19) United States
(12) Patent Application Publication
(10) Pub. No.: US 2022/0200229 A1
(43) Pub. Date: Jun. 23, 2022

(54) Optical Amplifier

(71) Applicant: Nippon Telegraph and Telephone Corporation, Tokyo (JP)

(72) Inventors: Takushi Kazama, Musashino-shi, Tokyo (JP); Takahiro Kashiwazaki, Musashino-shi, Tokyo (JP); Osamu Tadanaga, Musashino-shi, Tokyo (JP); Koji Embutsu, Musashino-shi, Tokyo (JP); Ryoichi Kasahara, Musashino-shi, Tokyo (JP); Takeshi Umeki, Musashino-shi, Tokyo (JP); Nobutatsu Koshobu, Musashino-shi, Tokyo (JP)

(21) Appl. No.: 17/611,938

(22) PCT Filed: May 27, 2019
(86) PCT No.: PCT/JP2019/020823

§ 371 Date: Nov. 17, 2021

(51) Int. Cl. H01S 3/109; H01S 3/10; H01S 3/108; H01S 3/067

(52) U.S. Cl. CPC H01S 3/109; H01S 3/06754; H01S 3/1083; H01S 3/10007

(57) ABSTRACT

A configuration of an excitation light generation device for providing an excitation light having a good SN ratio to a PSA is disclosed. Further, a configuration of a relay amplifier of the PSA including the excitation light generation device is also shown. The following disclosure includes the excitation light generation device, an optical amplification device including the excitation light generation device, and an optical transmission system. More specifically, the excitation light generation device for maintaining the SN ratio of the excitation light in a high state by utilizing an optical sensitive amplification function with respect to the excitation light generated by an optical phase lock loop is disclosed. The excitation light generation device of the present disclosure generates a local oscillation excitation light using the OPLL and having a sufficiently high SN ratio, which makes an inherent low noise operation of the PSA possible even to a signal light having a high SN ratio.

### TECHNICAL FIELD

The present invention relates to an optical amplification device used in an optical communication system and an optical measurement system.

### BACKGROUND ART

In an optical transmission system of the conventional technique, in order to regenerate a signal which has been attenuated while propagating through an optical fiber, an identification and regeneration optical repeater has been used for converting an optical signal into an electric signal and regenerating the optical signal after a digital signal is identified. However, this identification and regeneration optical repeater has disadvantages. For example, a response speed of an electronic component that converts the optical signal into the electric signal is limited, and power consumption is increased as the speed of the signal transmission becomes fast.

In order to solve these problems, a laser amplifier that directly amplifies an optical signal has been launched. Then, a phase sensitive amplifier (PSA) from which a further better transmission quality can be expected has been studied. This PSA has a function to reshape a signal light waveform and a phase signal. In addition, since the PSA can suppress a spontaneous emission light having a quadrature phase that is unrelated to the signal and also keep an in-phase spontaneous emission light minimum, it is possible to maintain the same SN ratio of the signal light before and after amplification without deterioration.

FIG. 1 shows a basic configuration of a conventional PSA. As shown in FIG. 1, a PSA 100 is provided with a phase sensitive optical amplification unit 101 that uses optical parametric amplification, an excitation light source 102, and an excitation light phase control unit 103, and a first and second optical splitters 104-1 and 104-2. As shown in FIG. 1, a signal light 110 inputted into the PSA 100 is split to two beams by the optical splitter 104-1. One of them enters the phase sensitive optical amplification unit 101, and the other enters the excitation light source 102. An excitation light 111 emitted from the excitation light source 102 enters the phase sensitive optical amplification unit 101 after the phase thereof is adjusted via the excitation light phase control unit 103. Based on the inputted signal light 110 and the excitation light 111, the phase sensitive amplification unit 101 outputs an output signal light 112.

The phase sensitive optical amplification unit 101 has characteristics to amplify the signal light 110 when a phase of the entered signal light 110 and the phase of the excitation light 111 become identical, and to attenuate the signal light 110 when a quadrature phase relationship is established in which the phases of the two are deviated by 90 degrees. By using these characteristics, if the phases between the excitation light 111 and the signal light 110 are made identical such that an amplification gain is maximum, the spontaneous emission light in the quadrature phase of the signal light 110 is not to be produced. In addition, with respect to an in-phase component, a spontaneous emission light more excessive than a noise of the signal light is not to be produced. In other words, the signal light 110 can be amplified without deteriorating the S/N ratio.

In order to effect phase synchronization between the signal light 110 and the excitation light 111 as described above, the excitation light phase control unit 103 controls the phase of the excitation light 111 so as to be synchronized with the phase of the signal light 110 split by the first optical splitter 104-1. In addition, the excitation light phase control unit 103 detects a part of the output signal light 112 split by the second optical splitter 104-2 with a narrow-band detector, and controls the phase of the excitation light 111 such that an amplification gain of the output signal light 112 is maximum. As a result, in the phase sensitive optical amplification unit 102, the optical amplification without deterioration of the S/N ratio is implemented based on the above principle.

Note that the excitation light phase control unit 103 may be configured to directly control the phase of the excitation light source 102, in addition to being configured to control the phase of the excitation light 111 at the output side of the excitation light source 102. Additionally, when a light source producing the signal light 110 is disposed in the vicinity of the phase sensitive optical amplification unit 101, a part of the light source for the signal light can be split to be used as the excitation light.

Methods to use nonlinear optical media to perform the above-described parametric amplification include a method in which a second-order nonlinear optical material represented by a periodically poled LiNbO₃ (PPLN) waveguide is used, and a method in which a third-order nonlinear optical material represented by a quartz glass fiber is used.

FIG. 2 exemplifies a configuration of a PSA of the conventional technique utilizing the PPLN waveguide that is disclosed in the non-patent literature 1 and the like. A PSA 200 shown in FIG. 2 is provided with an erbium-devoid fiber laser amplifier (EDFA) 201, first and second second-order nonlinear optical elements 202 and 204, first and second optical splitters 203-1 and 203-2, a phase modulator 205, an optical fiber expander 206 which uses a PZT, a polarization maintaining fiber 207, a photodetector 208, a phase lock loop (PLL) circuit 209. The first second-order nonlinear optical element 202 is provided with a first space optical system 211, a first PPLN waveguide 212, a second space optical system 213, and a first dichroic mirror 214. The second second-order nonlinear optical element 204 is provided with a third space optical system 215, a second PPLN waveguide 216, a fourth space optical system 217, a second dichroic mirror 218, and a third dichroic mirror 219.

The first space optical system 211 couples a light inputted from an input port of the first second-order nonlinear element 202 to the first PPLN waveguide 212. The second space optical system 213 couples a light outputted from the first PPLN waveguide 212 to an output port of the first second-order nonlinear optical element 202 via the first dichroic mirror 214. The third space optical system 215 couples a light inputted from an input port of the second second-order nonlinear optical element 204 to the second PPLN waveguide 216 via the second dichroic mirror 218. The fourth space optical system 217 couples a light outputted from the second PPLN waveguide 216 to an output port of the second second-order nonlinear optical element 204 via the third dichroic mirror 219.

In the example shown in FIG. 2, a signal light 250 that has entered the PSA 200 is split by the optical splitter 203-1. One of the lights enters the second second-order nonlinear optical element 204, and the other light enters the EDFA 201 as an excitation fundamental wave light 251 after the phase thereof is controlled via the phase modulator 205 and the optical fiber expander 206. In order to obtain a power enough to obtain a nonlinear optical effect from a feeble laser beam used for optical communication, the EDFA 201 amplifies the entered excitation fundamental wave light 251 and emits the amplified light to the first second-order nonlinear optical element 202. In the first second-order nonlinear optical element 202, a second harmonic light (SH light) 252 is generated from the entered excitation fundamental wave light 251, and the generated SH light 252 enters the second second-order nonlinear optical element 204 via the polarization maintaining fiber 207. In the second second-order nonlinear optical element 204, phase sensitive amplification is performed by performing degenerate parametric amplification of the entered signal light 250 and the SH light 252 so as to output an output signal light 253.

In the PSA, in order to amplify only the light having a matched phase with the signal, it is necessary that the phase of the signal light and the phase of the excitation light are coincident as described above, or deviated by π radian. In other words, when a second-order nonlinear optical effect is used, a phase ϕ2ωs of the excitation light having a wavelength that corresponds to the SH light and a phase ϕωs of the signal light need to satisfy the relationship of the following (Expression 1). Here, it is assumed that n is an integer.

Δϕ=½(ϕ2ωs−ϕωs)=nπ (Expression 1)

FIG. 3 is a graph showing the relationship of a phase difference Δϕ between the input signal light and the excitation light with a gain (dB) in the PSA that utilizes the second-order nonlinear optical effect. The graph shows that the gain is maximum when Δϕ is −π, 0, or π.

In the configuration shown in FIG. 2, in order to synchronize the phases of the signal light 250 and the excitation fundamental wave light 251, after performing phase modulation to the excitation fundamental wave light 251 by a feeble pilot signal using the phase modulator 205, a part of the output signal light 253 is split and detected with the detector 208. This pilot signal component is minimum in a state in which the phase difference Δϕ shown in FIG. 3 is minimum and the phase lock is achieved. Therefore, a feedback is performed by using the PLL circuit 209 such that the pilot signal is minimum, that is, an amplification output signal is maximum. The feedback operation as described above allows a phase of the excitation fundamental wave light 251 to be controlled, thereby making it possible to achieve the phase lock of the signal light 250 and the excitation fundamental wave light 251.

In the above-described configuration in which the PPLN waveguide is used as the nonlinear medium to emit the signal light 250 and the SH light 252 to the second second-order nonlinear optical element 204 for performing the degenerate parametric amplification, a component of the excitation fundamental wave light is removed by using characteristics of dichroic mirror 214, for example. This allows only the SH light 252 and the signal light 250 to enter a parametric amplification medium such as the second second-order nonlinear optical element 204. Then, optical amplification with a low noise is made possible because a noise due to a mixture of the spontaneous emission light produced by the EDFA 201 can be prevented.

The PSA not only produce little intensity noise but also has an effect to reduce a phase noise. Therefore, if the PSA is used as a relay amplifier or a preamplifier of a receiver in optical communication, reduction in nonlinear distortion and the like of a transmission path is possible, which is effective in improving the quality of an optical signal. Non-patent literature 2 discloses a configuration example of relay amplification of the PSA using a degenerate parametric process.

On the other hand, the phase sensitive amplification using the above-mentioned degenerate parametric process has a characteristic to attenuate a quadrature phase component as shown in FIG. 3. For this reason, it can be used only to amplify an ordinary intensity modulation signal and signals modulated by using binary phase modulation such as IMDD, BPSK, DPSK. In addition, the phase sensitive amplification using the degenerate parametric process can perform the phase sensitive amplification only to a signal light of one wavelength. In order to apply the PSA to the optical communication technique, a configuration is required that can correspond to various optical signals such as a multi-value modulation format signal and a wavelength multiplex signal. Non-patent literature 3 disclosed a configuration based on non-degenerate parametric amplification in which a phase conjugate light that makes a pair with the signal light is prepared in advance to be used as an input light to the nonlinear medium such as the PPLN.

Here, attention will be paid to a more specific method of the phase synchronization when the PSA is applied to optical communication. As in the basic configuration shown in FIG. 2, when the PSA is disposed immediately after the transmitter of the optical signal, and the light source producing the signal light is near the phase sensitive optical amplification unit, a part of the output of the light source for the signal light can be split and used as an excitation light. However, when the PSA is used as a relay amplifier in optical transmission, it is necessary to extract an average phase from the signal light to which light modulation is performed and then to generate an excitation light in synchronization with a carrier-wave phase of the signal. When the PSA is used as a relay amplifier in optical transmission, it is important to configure the PSA including a method of extracting the carrier wave phase.

As a configuration in which the PSA is applied to a relay amplifier, the configuration in which a pilot tone of a continuous wave (CW) having the same phase as the carrier phase of the modulation signal is used (non-patent literature 4) is known. It is possible to generate a local oscillation excitation light that is phase-locked with a signal light by sending out a pilot tone to an optical fiber transmission path together with a signal light to perform optical injection lock to the local oscillation light installed at a relay amplification point. However, in this configuration, there is a problem that the pilot tone that is transmitted with the signal light occupies a part of the signal band, thereby deteriorating band utilization efficiency. There is also a problem that an unnecessary conversion light is produced due to four light wave mixture in a fiber when the CW light is sent together, thereby deteriorating the signal quality.

As another configuration applied to the relay amplifier, a configuration has been proposed in which an optical phase lock loop (OPLL) is used (non-patent literature 5). In the configuration of this OPLL, the carrier wave phase is extracted from a modulated signal light without requiring a pilot tone, thereby allowing the PSA to be applied to the relay amplifier without lowering the band utilization efficiency.

FIG. 4 is a configuration diagram of a relay type PSA using the OPLL of the conventional technique. As main components, a relay type PSA 300 includes a local oscillation phase lock circuits 301 to generate an excitation light 327, and a PSA 302. A part of a signal light 304 is tapped by a coupler 306 and inputted into a first second-order nonlinear optical element 309 of the local oscillation phase lock circuit 301 via a BPF 307 and EDFA 308. A local oscillation light 325 from a local oscillation light source 303 is inputted via an EDFA 315 into an LN phase modulator 314 that will be described below. The local oscillation phase lock circuit 301 operates to generate an excitation light 326 that is phase-locked with the signal light 304 from the tapped signal light as described below.

FIG. 5 shows diagrams schematically describing optical frequency spectra of a signal light and the like in each part of the OPPL of FIG. 4. Hereinafter, the operation of the relay type PSA 300 will be described while alternately referring to FIGS. 4 and 5. As shown in FIG. 5, the signal light 304 in FIG. 4 is formed of a pair 400 of a signal light ϕs that is subjected to phase modulation and a phase conjugate light (idler light) ϕi. At a transmission source of the signal light, the pair 400 of the signal light ϕs and the phase conjugate light ϕi is generated by using a pump light ϕₚᵤₘₚ, and transmitted to an optical transmission path as the signal light 304. In the following description, ϕ denotes an optical frequency of each signal or the like.

Returning to FIG. 4, the propagated signal light 304 is tapped by the optical coupler 306, passed through the BPF 307 to restore the intensity by the EDFA 308, and then inputted into the first second-order nonlinear optical element 309. In the first second-order nonlinear optical element 309, a sum frequency light (OSF) 320 is generated from the above-described pair 400 of the signal light and the phase conjugate light by a sum frequency generation (SFG: Sum Frequency Generation) mechanism in the second-order nonlinear medium (here, which is the PPLN). The generation of the sum frequency light from the pair of the signal light and the phase conjugate light by the SFG process is shown as ϕ_{SF} 401 in FIG. 5. As shown in FIG. 5, the optical frequency of the sum frequency light ϕ_{SF} is twice as large as the optical frequency ϕₚᵤₘₚ of the pump light, that is, 2ϕₚᵤₘₚ. At this point of time, the phase modulation component is canceled by the SFG process of the signal light ϕs and the phase conjugate light ϕi, which generates the sum frequency light ϕ_{SF} 401 in which a carrier wave phase has been regenerated. In other words, in the sum frequency light ϕ_{SF} 401 that is obtained from the signal light 304 subjected to data modulation by the first second-order nonlinear optical element 309, phase information of the carrier wave that has been used to generate the signal light at the transmission source is regenerated.

The local oscillation light 325 generated from the local oscillator (Lo) 303 is used in the OPLL that will be further describe below, so as to generate an excitation light in synchronization with the sum frequency light ϕ_{SF} 401 from which the carrier wave phase is extracted. The local oscillation light 325 is amplified by the EDFA 315, and then subjected to, for example, phase modulating by the LN modulator 314. As shown in the spectra of FIG. 5, in the local oscillation light ϕ_{LO}, a plurality of sideband lights (side waves) 403, that is, components such as optical frequencies ϕ_{L-1}, ϕ_{L+1}, ϕ_{L-2}, and ϕ_{L+2} are produced due to modulation above and below the optical frequency ϕL_{O}.

Of these sideband lights, a primary sideband light ϕ_{L+1} on a high frequency side is converted into a second harmonic (SH) light by a second harmonic generation (SHG) process in the second-order nonlinear medium (PPLN) of the second second-order nonlinear optical element 310. Referring again to the spectra of FIG. 5, from the primary sideband light ϕ_{L+1}, an SH light ϕ_{SH} (=2ϕ_{L+1}) 402 thereof is generated by the SHG process of the second second-order nonlinear optical element 310. An optical frequency of the local oscillation light 325 and a modulation frequency of the LN modulator 314 are selected such that the sum frequency light ϕ_{SF} 401 having the above-described information of the carrier wave phase and the SH light ϕ_{SH} 402 have the same optical frequency.

Between the above-described sum frequency light ϕ_{SF} 401 and SH light ϕSH 402, frequencies and phases are compared by a balanced detector 311. A detection output 322 of the alternating current corresponding to the differences in frequency and phase is obtained from the balanced detector 311, and a low-speed error signal 323 is further obtained by a loop filter 312. The error signal 323 is inputted as a control signal of a VCO 313. An oscillation output 324 from the VCO 313 is supplied to the above-mentioned LN modulator 314 as a modulation signal for generating a sideband light. In this way, a feedback loop of the OPLL is formed by a path from the LN modulator 314, the balanced detector 311, the loop filter 312, and the VCO 313. Then, an output frequency of the VCO 313 is adjusted such that a frequency difference and a phase difference between the sum frequency light ϕ_{SF} 401 and the SH light ϕ_{SH} 402 are resolved, which changes the optical frequency and the phase of the primary sideband light ϕ_{L+1}. As a result, the primary sideband light ϕ_{L+1} in synchronization with the optical frequency and the phase of the sum frequency light ϕ_{SF} 401 is obtained.

The modulated local oscillation light including the phase-locked primary sideband light ϕ_{L+1} is split at the output side of the LN modulator 314, and only the primary sideband light ϕ_{L+1} is cut out from a split light 326 by the BPF 316 as shown in FIG. 5. The phase locked sideband light ϕ_{L+1} is supplied to the PSA 302 as a phase-locked excitation light 327 after the intensity thereof is recovered by the EDFA 317.

The operation of the above-described local oscillation phase lock circuit 301 can be summarized as follows. First, by the SFG process of the first second-order nonlinear optical element 309, the average phase of the signal light 304 is extracted in the sum frequency light ϕ_{SF} 401. Secondly, the error signal 323 based on the phase difference between the sum frequency light ϕ_{SF} 401 and the SH light ϕ_{SH} generated from the primary sideband light ϕ_{L+1} of the local oscillation light 325 is generated. Thirdly, the VCO 313 is controlled by the error signal 323 so that the optical frequency of the primary sideband light ϕ_{L+1} is controlled to be phase-clocked with the sum frequency light ϕ_{SF} 401. To the fourth, only the phase-locked primary sideband light ϕ_{L+1} is cut out by the BPF 316 to recover the intensity thereof so as to generate the excitation light of the PSA.

By using the excitation light obtained by the OPLL as described above, the PSA 302 can be applied to a relay amplifier. When an accuracy of the above-described cut out of the primary sideband light ϕ_{L+1} is not sufficient, a harmonic excitation light component, which is originally unnecessary but produced by the fundamental wave light ϕ_{LO} and the secondary sideband light ϕ_{L+2}, becomes a noise and is superimposed at the time of signal optical amplification in the PSA 302. For this reason, the primary sideband light in the OPLL needs to be cut out with a sufficient level difference (contrast) after the level of the adjacent unnecessary fundamental wave ϕ_{LO} and sideband light is sufficiently attenuated.

### CITATION LIST

### Non-Patent Literature

Non-Patent Literature 1: T. Umeki, O. Tadanaga, A. Takada and M. Asobe, “Phase sensitive degenerate parametric amplification using directly-bonded PPLN ridge waveguides,” Optics Express, 2011, Vol. 19, No. 7, p. 6326-6332
Non-Patent Literature 2: Takeshi Umeki, Masaki Asobe, and Hirokazu Takenouchi, “In-line phase sensitive amplifier based on PPLN waveguides,” Optics Express, May 2013, Vol. 21, No. 10, p. 12077-12084
Non-Patent Literature 3: M. Asobe, T. Umeki, H. Takenouchi, and Y. Miyamoto, “In-line phase-sensitive amplifier for QPSK signal using multiple QPM LiNbO3 waveguide,” In Proceedings of the OptoElectronics and Communications Conference, OECC, 2013, PDP paper PD2-3
Non-Patent Literature 4: M. Abe, T. Kazama, T. Umeki, K. Enbutsu, Y. Miyamoto, and H. Takenouchi, “PDM-QPSK WDM Signal amplification using PPLN-based polarization-independent in-line phase-sensitive amplifier,” in Proc. 42nd European Conference on Optical Communication (ECOC' 16), 2016, paper W. 4. P1. SC2. 4
Non-Patent Literature 5: Y. Okamura et al., “Optical pump phase locking to a carrier wave extracted from phase-conjugated twin waves for phase-sensitive optical amplifier repeaters,” 2016, Opt. Exp., vol. 24, no. 23, pp. 26300-26306

### SUMMARY OF THE INVENTION

### Technical Problem

However, in the configuration of the conventional technique shown in FIG. 4 in which the excitation light is generated by the OPLL to operate the PSA as a relay amplifier, there have been the problems described below. In order to secure a low noise property in the PSA of FIG. 4, the excitation light 327 having a good SN ratio with respect to a signal light is required. If the SN ratio of the excitation light 327 is unsatisfactory, or there is instability in the level of the excitation light, the quality of the amplified signal light is lowered. By way of example, a fluctuation in power of the excitation light directly affects a gain of the PSA.

FIG. 6 is a diagram showing a relationship between the excitation light intensity and the gain in the PSA. The horizontal axis represents an excitation light intensity and the vertical axis represents a gain of the PSA. The amplification gain of the PSA is described as shown in the following expression, in which the amplification gain is determined by the intensity of the excitation light.

G_{PSA}=(exp(ηP))^{1/2} (Expression 2)

In the above expression, G_{PSA} represents a gain, η represents an efficiency of the PPLN, and P represents an excitation light intensity. When the excitation light to be used for the amplification has a noise component, a fluctuation occurs in the excitation light intensity due to a beat between the excitation light and a noise light. As is schematically shown in FIG. 6, since the amplification gain of the PSA is dependent on the intensity of the excitation light, the fluctuation is also transferred to the amplified output light if there is a fluctuation in the excitation light intensity. As is apparent from (Expression 2), the amplification gain G_{PSA} exponentially increases with respect to the excitation light intensity P. Therefore, the larger the amplification gain G_{PSA}, the more the fluctuation of the output light is increased. For this reason, unless the SN ratio of the excitation light has been able to be sufficiently secured, the low noise property inherent in the PSA cannot be utilized. To be more exact, low noise amplification is not possible if the SN ratio of the excitation light is not sufficiently good with respect to the SN ratio of the signal light to be amplified. Therefore, for the low-noise optical amplification of the signal light, the SN ratio of the excitation light should be suppressed to be sufficiently small, so as to maintain the quality of the excitation light.

In optical sensitive amplification, it is ideally desirable to use, as an excitation light, the light 250 outputted from the light source as it is, as in the basic configuration shown in FIG. 2. However, in the configuration in which the excitation light is generated by the OPLL as shown in FIG. 4, the sideband light that has passed through the LN modulator 314 is used as the excitation light. For this reason, the level of the excitation light is lowered (decrease in S) because of not only a large optical loss caused by the modulation but also an insertion loss of the modulator itself and a loss by a filter for cutting out the sideband light. Further, accumulation of an excess noise occurs by the EDFA 317 for recovering the level of the excitation light (increase in N). Due to these effects, it is not possible to maintain the SN ratio of the phase-locked excitation light 327 supplied to the PSA 302 sufficiently high. As a result, when the excitation light having a deteriorated SN ratio is used as described above, a problem arises that the low-noise amplification is not possible with respect to the signal light having a good SN ratio and a good signal quality because the excitation light has a low quality.

The present invention has been made in consideration of these problems, and has as its object to provide a configuration in which an excitation light having a high SN ratio is generated in a relay type PSA.

### Means for Solving the Problem

An embodiment of the present disclosure is a device that generates an excitation light for an optical phase sensitive amplifier to amplify a signal pair of a signal light and an idler light of the signal light, which is provided with an optical phase lock unit (501) to generate a plurality of sideband lights in synchronization with a phase of the signal pair by an optical phase lock loop (OPLL) with respect to the plurality of sideband lights produced by modulating a local oscillation light, and an excitation light cut out unit (600) to extract, as an excitation light, one sideband light of the plurality of synchronized sideband lights, wherein the excitation light cut out unit (600) includes a first second-order nonlinear optical element (602) to generate a second harmonic (610) of the local oscillation light, a phase adjuster (606) to adjust a phase for each sideband light with respect to the synchronized plurality of sideband lights, a second second-order nonlinear optical element (603) to perform parametric amplification to the phased-adjusted sideband light, means (604, 605) to synchronize a phase of the second harmonic and a phase of the one sideband light amplified by the second second-order nonlinear optical element, and an optical filter to extract only the one sideband light.

It is preferable that the phase adjuster is configured to set the phase between the one sideband light and the second harmonic such that an amplification operation is performed in the second second-order nonlinear optical element, and set the phases between other sideband lights excluding the one sideband light as well as the local oscillation light and the second harmonic such that an attenuation operation is performed in the second second-order nonlinear optical element.

The optical phase lock unit (501) can include
a third second-order nonlinear optical element (509) to generate a sum frequency light from the signal pair, a modulator (514) to produce the plurality of sideband lights by modulating the local oscillation light, a fourth second-order nonlinear optical element (510) to generate a second harmonic of the sideband light from the modulator, phase lock means (511, 512, 513) to detect a phase difference between the one sideband light of the plurality of sideband lights and the sum frequency light and to provide a feedback to the modulator according to the phase difference, a first splitter (516) to split the local oscillation light at a preceding stage side of the modulator, and a second splitter (517) to split the plurality of synchronized sideband lights at a subsequent stage side of the modulator.

The one sideband light may be a primary sideband light on a high frequency side of the local oscillation light. In addition, the one sideband light may be a primary sideband light on a low frequency side thereof, or further, a secondary sideband light.

Preferably, an optical waveguide included in the second-order nonlinear optical element is a directly bonded ridge waveguide, and the directly bonded ridge waveguide can be made of any material from among iNbO₃, KNbO₃, LiTaO₃, LiNb₍ₓ₎Ta₍₁₋ₓ₎O₃(0≤x≤1), and KTiOPO₄, or a material in which at least one kind selected from a group consisting of Mg, Zn, Sc, and In is added as an additive to any of these materials.

Another embodiment of the present disclosure can be a relay type optical amplification device provided with a phase sensitive amplifier that includes a fifth second-order nonlinear optical element to generate a second harmonic from the excitation light generated by the excitation light cut out unit, a sixth second-order nonlinear optical element to perform non-degenerate parametric amplification of the signal pair, and a phase lock means to synchronize the phase of the signal pair and the phase of the excitation light.

### Effect of the Invention

It is possible to provide a configuration in which an excitation light having a high SN ratio is generated in a relay type PSA.

### BRIEF DESCRIPTION OF DRAWINGS

FIG. 1 is a diagram for explaining the configuration of the phase sensitive optical amplifier according to the conventional technique.

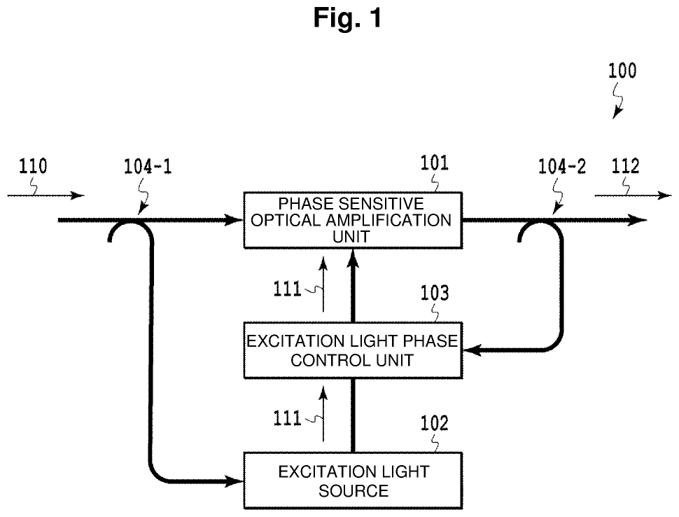

FIG. 2 is a diagram of the configuration of the phase sensitive optical amplifier using a second-order nonlinear optical effect.

FIG. 3 is a graph illustrating the relationship of the phase difference Δϕ of the input signal light and the excitation light with the gain.

FIG. 4 is a configuration diagram of the relay type PSA using the optical phase lock loop according to the conventional technique.

FIG. 5 shows diagrams for schematically describing spectra of a signal light and the like in each part of the OPLL.

FIG. 6 is a diagram showing the relationship between the excitation light intensity and the PSA gain.

FIG. 7 is a diagram showing the configuration of the optical amplification device using the OPLL according to the present disclosure.

FIG. 8 shows diagrams for describing an action to each sideband light in the excitation light generation device.

FIG. 9 is a diagram for describing a gain saturation characteristic in a PPLN waveguide module.

FIG. 10 is a diagram showing a relationship between an SN ratio of an input signal light and a noise factor of the relay type PSA.

### DESCRIPTION OF EMBODIMENTS

In the following description, a configuration of an excitation light generation device in which an excitation light having a good SN ratio is provided to a PSA is disclosed. Further, a configuration of a relay amplifier of the PSA that includes the excitation light generation device is also shown. The following disclosures include the excitation light generation device, and an optical amplification device and an optical transmission system that include the excitation light generation device. More specifically, the excitation light generation device is disclosed that maintains an SN ratio of the excitation light in a high state by using an optical sensitive amplification function, with respect to the excitation light generated by the OPLL. An operation as a relay type PSA, which uses an excitation light with a low noise that is supplied from this excitation light generation device, is disclosed.

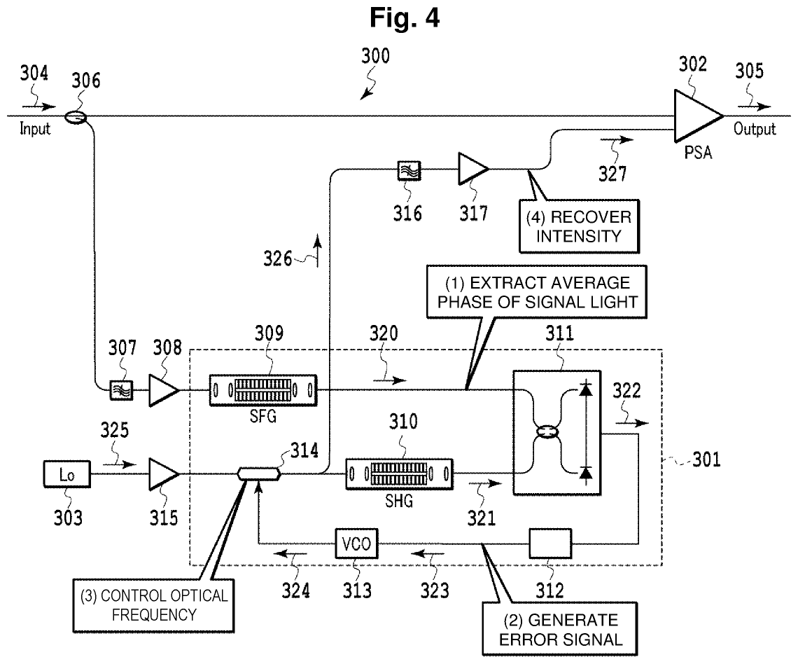

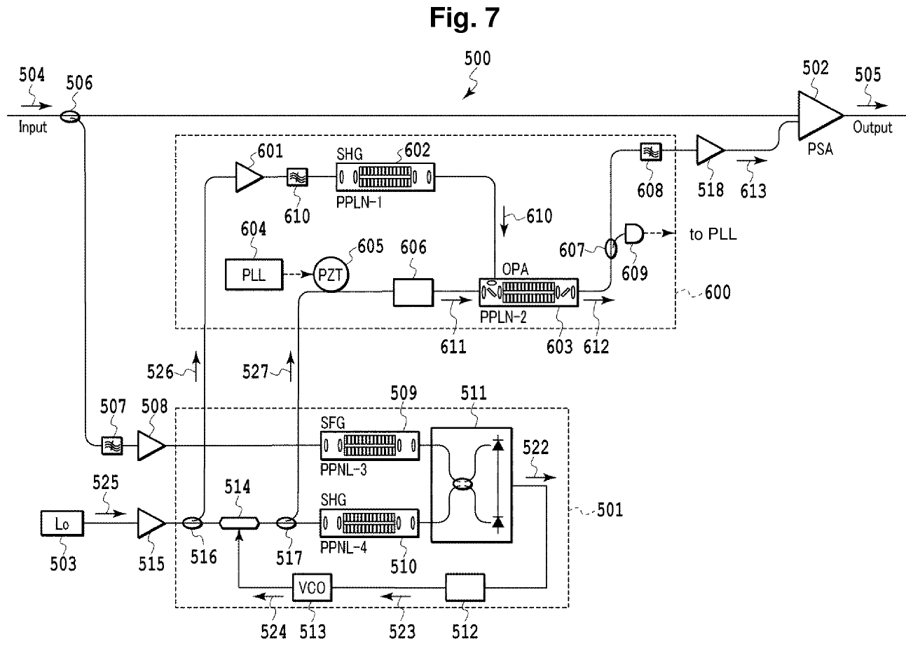

FIG. 7 is a diagram showing the configuration of an optical amplification device 500 that uses the OPLL according to the present disclosure. As main components thereof, the optical amplification device 500 is provided with a PSA 502, an optical phase lock unit 501 for generating an excitation light synchronized with a signal light by the OPLL, and an excitation light cut out unit 600. The configurations and operations of the PSA 502 and the optical phase lock unit 501 are generally the same as the configuration and the operation of the conventional technique showed in FIG. 4. The excitation light cut out unit 600 maintains an excitation light, which is obtained from the optical phase lock unit 501 and phase-locked by the OPLL, in a high SN ratio and supply the excitation light with a low noise to the PSA 501. The excitation light cut out unit 600 maintains an excitation light that is phase-locked by the OPLL obtained from the optical phase lock unit 501 in a high SN ratio, so as to supply the excitation light of low noise to the PSA 501. The excitation light cut out unit 600 has a function of the PSA and a function of a bandpass filter, and a BPF 316 in FIG. 4 is replaced with the excitation light cut out unit 600. The optical phase lock unit 501 and the excitation light cut out unit 600 are to operate as excitation light generation devices.

Hereinafter, a configuration and an operation of each component of the optical amplification device 500 will be described with reference to FIG. 7. As described above, the configuration of the optical phase lock unit 501 is generally the same as the configuration of the local oscillation phase lock circuit 301 in the OPLL configuration of the conventional technique of FIG. 4. Therefore, differences between them will be described. A signal light 504 is tapped by an optical coupler 506 and inputted into a third second-order nonlinear optical element (PPLN-3) 509 via a BPF 507 and an EDFA 508. A local oscillation light 525 from a local oscillation light source 503 is inputted into an LN modulator 514 via an EDFA 515. An excitation light modulated by the LN modulator is input into a fourth second-order nonlinear optical element (PPLN-4) 510.

Here, the configuration is different from that of FIG. 4 in that before and after the LN modulator 514, optical couplers 516 and 517 are provided. The optical coupler 516 at the preceding stage splits a zeroth component of the local oscillation light, that is, the excitation light to supply a zeroth component light 526 to the excitation light cut out unit 600. The optical coupler 517 at the subsequent stage splits the local oscillation light including a primary sideband light and subjected to modulation to supply the modulated local oscillation light 527 to the excitation cut out unit 600. These split signals will be further described below together with the operation of the excitation light cut out unit 600.

A detection output 522 is obtained from a balanced detector 511, and a low-speed error signal 523 is further obtained from the detection output 522 by a loop filter 512. The error signal 523 is inputted as a control signal of the VCO 513. An oscillation output 524 from the VCO 513 is supplied to the above-mentioned LN modulator 514 as a modulation signal for generating a sideband signal. The operation of the OPLL is the same as in the case of FIG. 4. Therefore, the description thereof will be omitted.

The excitation light cut out unit 600 is provided with a first second-order nonlinear optical element (PPLN-1) 602 and a second second-order nonlinear optical element (PPLN-2) 604. Both of them are, for example, PPLN waveguide modules that operate to maintain the SN ratio of the excitation light produced by the primary sideband light from the optical phase lock unit 501 as will be described later. The zeroth component light 526 split at the preceding stage of the LN modulator 514 described above is inputted, via a EDFA 601 and a BPF 614, into the first second-order nonlinear optical element (PPLN-1) 602 that generates an excitation light of the SH band by the SHG process. In the first second-order nonlinear optical element 602, an SH light 610 of the zeroth component light 526 is generated by the SHG process.

The modulated local oscillation light 527 split at the subsequent stage of the LN modulator 514 described above is inputted into the second second-order nonlinear optical element (PPLN-2) 603 via a piezoelectric (PZT) type optical fiber expander 605 and a phase adjuster 606. The second second-order nonlinear optical element 603 performs a phase sensitive amplification operation to the phase-adjusted primary sideband light 611 by an optical parametric amplification (OPA) process. In the amplified primary sideband light 612, only the primary sideband light is cut out by a BPF 608 to be inputted into an EDFA 518 as an excitation light.

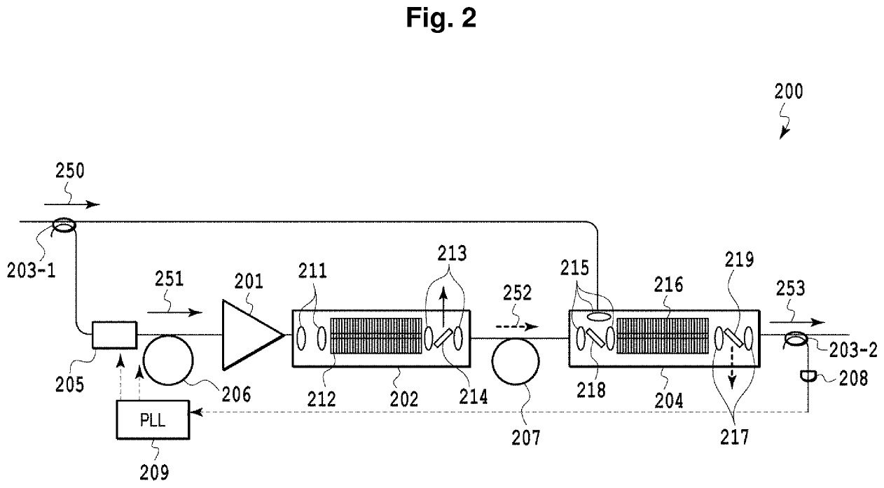

The amplified primary sideband light 612 is split by an optical coupler 607, and a detection signal is obtained by a photodetector 609. The detection signal is fed back to the phase lock loop (PLL) circuit 604. A path from the photodetector 609 that detects an output to which the optical sensitive amplification is performed, the PLL 604, and to the PZT 605 has the same configuration as that of the phase lock circuit described in FIG. 2.

The excitation light cut out unit 600 uses the zeroth component light 526 of the excitation light, that is, a carrier component of the excitation light, that has been split at the preceding stage of the LN modulator 514, as an excitation light of the parametric amplification by the second second-order nonlinear optical element 603. Therefore, phase sensitive amplification can be performed in one time to all components of the modulated local oscillation light 527 that has been split at the subsequent stage of the LN modulator 514. In other words, in the second second-order nonlinear optical element 603, the degenerate phase sensitive amplification to the zeroth component of the local oscillation light 527 and the non-degenerate phase sensitive amplification to the components other than the zeroth component of the local oscillation light 527 are used at the same time. Though the primary sideband light that is eventually used as an excitation light 613 is the one obtained by the LN modulator 514, it is supplied to the PAS 502 in a state in which the SN ratio deterioration is suppressed to a minimum by the parametric amplification operation in the second second-order nonlinear optical element 603.

As described above, in the excitation light generation device of the present disclosure, the optical phase lock unit 501 and the excitation light cut out unit 600 use four second-order nonlinear optical elements (PPLN waveguide modules). Of these, the third second-order nonlinear optical element 509 (PPLN-3), the fourth second-order nonlinear optical element 510 (PPLN-4), and the first second-order nonlinear optical element 602 (PPLN-1) are used to produce the SH light. Only the second second-order nonlinear optical element 603 (PPLN-2) is used for the parametric amplification. The three second-order nonlinear optical elements (PPLN-1, PPLN-3, and PPLN-4) for producing the SH light are each provided with the PPLN waveguide, as well as a first space optical system and a second space optical system before and after the PPLN waveguide. The first space optical system couples a light inputted into the PPLN waveguide module to the PPLN waveguide, and the second space optical system couples a light outputted from the PPLN waveguide to an output port of the PPLN waveguide module.

The second-order nonlinear optical element (PPLN-2) for the parametric amplification is provided with a PPLN waveguide, as well as a third space optical system and a first dichroic mirror on one end of the PPLN waveguide and a fourth space optical system and a second dichroic mirror on the other end of the PPLN waveguide. The third space optical system couples a light inputted into the PPLN waveguide module to the PPLN waveguide via the first dichroic mirror, and the fourth space optical system couples a light outputted from the PPLN waveguide to an output port of the PPLN waveguide module via the second dichroic mirror.

Hereinafter, fabrication method of the PPLN waveguide used in the excitation light generation device of the present disclosure will be described in an exemplarily manner. First, a periodic electrode having a period of approximately 17 μm is formed on LiNbO₃ added with Zn. Then, a polarization inversion grating according to an electrode pattern is formed in Zn:LiNbO₃ by an electric field application method. Next, the Zn:LiNbO₃ substrate having this periodical polarization inversion structure is directly bonded on LiTaO₃ serving as a clad, and both substrates are firmly joined by heat treatment of 500 C°. Subsequently, a core layer is thinned to around 5 m by polishing, and an optical waveguide of the ridge type is formed by using a dry etching process. A temperature of this optical waveguide can be adjusted with a Peltier element, and the length of the optical waveguide is set to 50 mm. The second-order nonlinear optical element having the PPLN waveguide formed in this manner is configured as a mode of a module that allows input and output of the light by a polarization maintaining fiber of the 1.5 μm zone. In the present disclosure, LiNbO₃ added with Zn is used, but other nonlinear materials such as KNbO₃, LiTaO₃, LiNbₓTa₁₋ₓO₃(0≤x≤1), and KTiOPO₄, or a material containing at least one kind selected from a group consisting of Mg, Zn, Sc, and In added to them as an additive, may be used.

Next, an operation of the optical amplification device 500 including the excitation light generation device shown in FIG. 7 will be described in more detail. The operation of the optical phase lock unit 501 is the same as the operation of the local oscillation phase lock circuit 301 in the OPLL configuration of the conventional technique shown in FIG. 4. To be more specific about the operating condition, modulation is performed to the local oscillation light 525 by a sine wave-like electric signal of approximately 20 GHz with respect to the LN modulator 514. In other words, the VCO 513 outputs an electric signal 524 of approximately 20 GHz in the vicinity of the medium value of the input error voltage (the VCO control voltage) 523.

The LN modulator 514 is an optical modulator that utilizes refractive index change caused by the Pockels effect of LiNbO₃ crystal, and widely used as an external modulator that modulates a CW light such as a DFB laser. In the present disclosure, an intensity modulator is used as the LN modulator 514, but a phase modulator may be used. By way of examples of optical frequencies of the respective units of the optical amplification device 500, the optical frequency of the signal light subjected to data modulation may be 193.1 THz, the optical frequency of the idler light may be 192.9 THz, and the optical frequency of the local oscillation light may be 193 THz.

In the configuration of the conventional technique shown in FIG. 4, the primary sideband light ϕ_{L+1} is cut out by the BPF 316 to be used as the phase-locked excitation light. The intensity of each sideband light obtained after modulation is lowered due to a modulator loss. Further, in order to use only the primary sideband light ϕ_{L+1} of the sideband lights as the excitation light, a filter 316 is used for cutting out. In order to obtain sufficient attenuation of unnecessary lights, loss in a transmission region including the sideband light ϕ_{L+1} is increased, which lowers the intensity of the excitation light. Since the amplification is performed by the EDFA 17 to compensate the intensity of the excitation light, the final SN ratio of the excitation light 327 is significantly deteriorated.

In contrast with this, in the configuration of the excitation light generation device of the present disclosure of FIG. 7, excessive SN ratio deterioration can be avoided by performing the phase sensitive amplification to the excitation light (the primary sideband light) generated via the LN modulator 304, with the second second-order nonlinear optical element 603 of the excitation light cut out unit 600. A local oscillation light, that is, a zeroth component light that is a carrier component of the excitation light is split at the preceding stage side of the LN modulator 514, and the split zeroth component light 526 is used as an excitation light of the parametric amplification. Thereby, phase sensitive amplification is performed in one time to all components of the modulated local oscillation light 527 split from the subsequent stage side of the LN modulator 514. There are two significances in causing the second second-order nonlinear optical element 603 to perform the phase sensitive amplification to the excitation light.

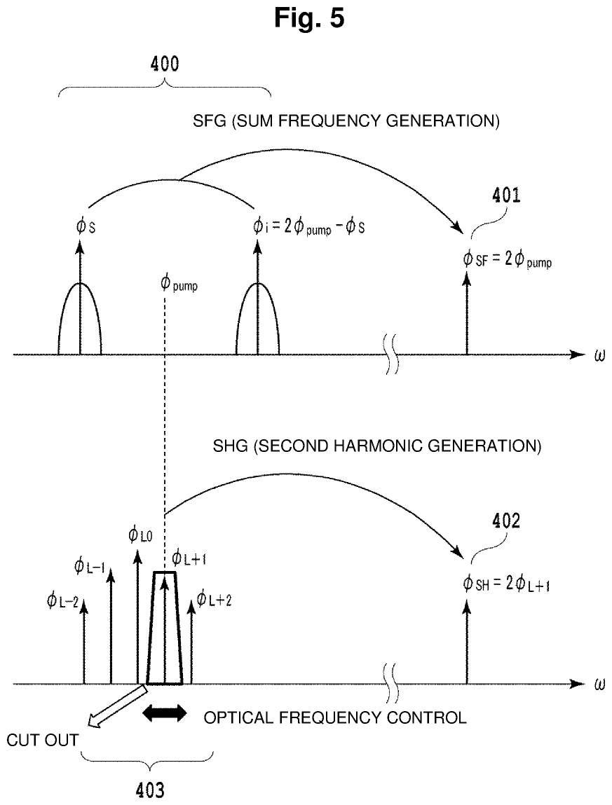

The first significance is that by using the amplification operation and the attenuation operation of the phase sensitive amplification, it is possible to have the second-order nonlinear optical element 604 to serve both functions as am amplifier and a filter. Referring to FIG. 5, for example, in the sideband light generated via the LN modulator 314, the sideband lights that are to be paired such as ϕ_{L-1} and ϕ_{L+1}, ϕ_{L-2} and ϕ_{L+2} are phase-locked with each other. For this reason, the phase sensitive amplification is possible to both a carrier component and a sideband component. Here, in the excitation light generation device of FIG. 7, the phase adjuster 606 is provided at the preceding stage side of the second second-order nonlinear optical element 603 (PPLN-2) that performs the phase sensitive amplification.

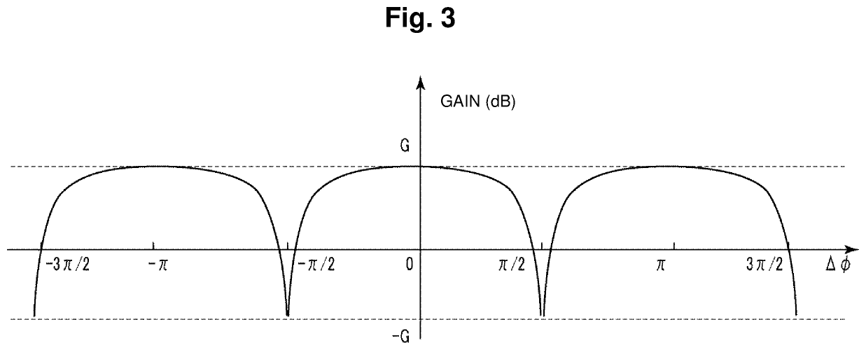

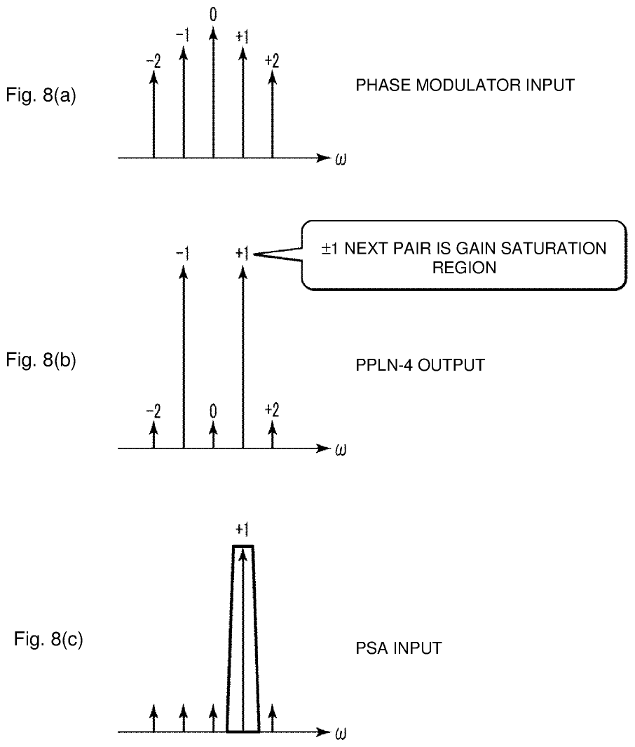

FIG. 8 shows diagrams for schematically describing effects to the respective sideband lights in the excitation light generation device of the present disclosure. FIG. 8 (a) shows a spectrum of a modulated excitation light immediately before the phase adjuster 606 of the excitation light cut out unit 600. A fundamental wave component of the excitation light indicated as 0 has the maximum level, primary sideband lights (+1, −1) and secondary sideband lights (+2, −2) are present on both sides thereof. Note that the number in the parenthesis shows an order of the sideband. Here, by the phase adjuster 606, the phase of the primary sideband lights (+1, −1) is adjusted in relation with the SH light 610 which is an excitation light such that the gain in the second second-order nonlinear optical element 603 is maximum. The relationship between the gain and the phase in the PSA of FIG. 3 should be referred to. On the other hand, the phases of the fundamental wave component and the secondary sideband light (+2, −2) are adjusted in relation with the SH light 610 such that the gain is minimum, that is, the attenuation is maximum in the second second-order nonlinear optical element 603.

Various items can be used as the phase adjuster 606, and by way of example, a filter with a wavelength selectivity using LCOS (Liquid Crystal On Silicon) can be used. With a filter made by the LCOS, an attenuation amount and a phase rotation amount can be adjusted for each wavelength. Additionally, as the phase adjuster, a combination of a wavelength multiplexer/demultiplexer and a phase modulator can be used.

FIG. 8 (b) shows a spectrum in an output of the second second-order nonlinear optical element 603. In the present disclosure, since the primary sideband light is used as an excitation light of the PSA 502 for relay amplification, the excitation light cut out unit 600 operates to amplify only the primary sideband lights (+1, −1) to be cut out as the excitation lights. The phase adjuster 606 is used to adjust a phase for each component of the sideband light of the modulate local oscillation light 527 such that only the sideband light that is desired to be cut out by the second second-order nonlinear optical element 603 is operated for amplification, and the remaining sideband lights and the like are operated for attenuation. Thereby, a large intensity difference can be obtained between the desired sideband light and the other components without producing an excessive optical loss.

Specifically, an amplification gain of the phase sensitive amplification by the second second-order nonlinear optical element 603 is 20 dB. On the other hand, at the time of the attenuation operation, an attenuation of −15 dB can be obtained in the second second-order nonlinear optical element 603. Therefore, the intensity difference (contrast) of approximately 35 dB or more can be obtained between the desired primary sideband light and other unnecessary sideband components. In order to obtain a further larger contrast with an optical power, a bandpass filter 608 is installed at the subsequent stage of the second second-order nonlinear optical element 603. As a result, as shown in FIG. 8 (c), the difference in level between the optical intensity of the desired excitation light and the optical intensity of the unnecessary sideband components is 50 dB in the entire excitation light cut out unit 600.

The second significance in performing the phase sensitive amplification to the excitation light by the second-order nonlinear optical element is that a gain saturation phenomenon of the parametric amplification can be used. In the parametric amplification, an amplified output higher than the optical intensity of the excitation light that serves as an energy source for amplification cannot be obtained. For this reason, gain saturation is caused when the light to be amplified approaches the optical intensity of the excitation light.

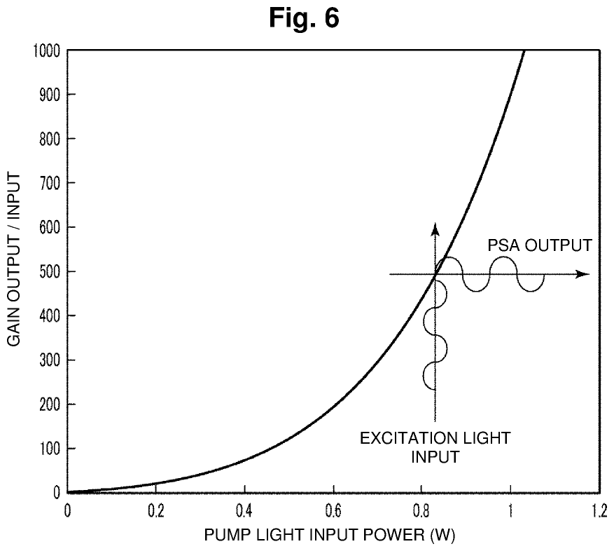

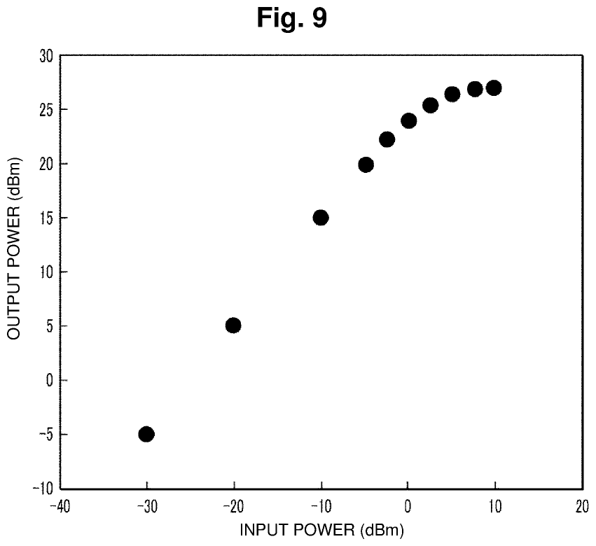

FIG. 9 is a diagram for describing the gain saturation characteristics in the PPLN waveguide module. The input/output characteristics with respect to a light having the optical frequency of 193.1 THz in a phase matching state is shown of the second second-order nonlinear optical element 603 in FIG. 7. Increase of the output power stops in the vicinity of 0 dBm of the input power of the light to be amplified, where the gain is saturated. Since the optical power to be outputted is constant with respect to the input optical power in the gain saturation region, the time fluctuation of the pump light described in FIG. 6 can be significantly reduced. Generally, the time variation of the laser beam output is also known as an intensity noise. In the excitation light cut out unit 600 of FIG. 7, by amplifying the primary sideband light in the gain saturation region, the intensity noise is compressed to improve the SN ratio of the amplified primary sideband light 612, that is, the SN ratio of the excitation light in the second second-order nonlinear optical element output. In other words, in the gain saturation region, since the optical power to be outputted is constant with respect to the input optical power, the intensity fluctuation is compressed to improve the quality of the excitation light. In order to use this gain saturation region, the output power of the local oscillation light is adjusted in the EDFA 515 immediately after the local oscillation light source 503 such that the power of the excitation light to be inputted into the second second-order nonlinear optical element 603 is 0 dBm or more.

As described above, the excitation light cut out unit 600 that performs the phase sensitive amplification to the excitation light with the second-order nonlinear optical element can cut out the primary sideband light of the excitation light without an excessive loss by using the two actions, namely, the amplification operation and the attenuation operation of the phase sensitive amplification. It is possible to suppress the SN ratio of the excitation light due to a decrease in intensity (decrease in S) caused by the modulator 514 and an increase in noise (increase in N) caused by the EDFA. Further, by using the gain saturation region of the phase sensitive amplification, it is possible to compress the time variation of the excitation light intensity and improve the SN ratio and the quality of the excitation light.

In order to stabilize the phase sensitive amplification operation by the second second-order nonlinear optical element 603 in the excitation light cut out unit 600, the optical coupler 607 is installed at the subsequent stage side of the second second-order nonlinear optical element 603 to take out a part of the output light. From the viewpoint of the parametric amplification of the second second-order nonlinear optical element, the SH light 610 is an excitation light, and the phase-adjusted primary sideband light 611 is a light targeted for amplification. A change of the optical intensity is detected by the photodetector 609, and then, using the PLL circuit 604, a feedback is performed to the PZT 605 such that the phase of the SH light 610, which is an excitation light, and the phase of the primary sideband light 611 targeted for amplification are synchronized.

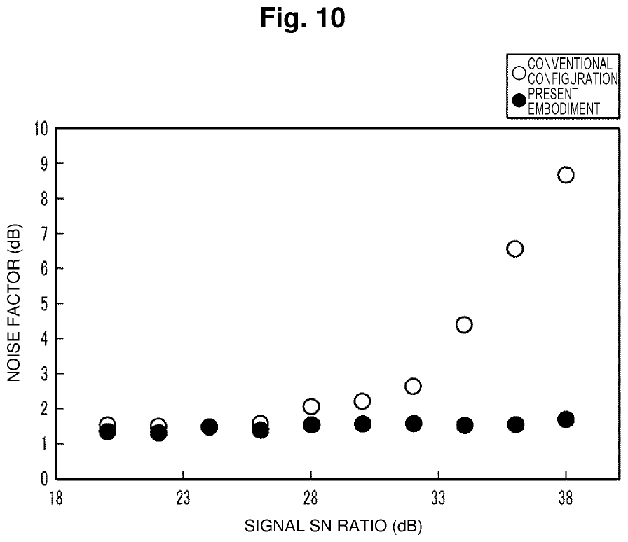

FIG. 10 is a diagram for showing the relationship between the SN ratio of the input signal light and the noise factor of the relay type PSA. The cases in which the excitation light according to the configuration of the conventional technique shown in FIG. 4 is supplied to the PSA are indicated by white dots, and the cases in which the excitation light is supplied to the PSA by the excitation light generation device of the present disclosure shown in FIG. 7 are indicated by black dots. The horizontal axis represents the SN ratio of the input signal lights 304 and 504, and the horizontal axis represents the noise factor of the relay type SAEs 302 and 502. It is shown that, when the excitation light is supplied to the relay type PSA configured by the conventional configuration, the noise factor gradually starts to deteriorate around the point where the SN ratio of the input signal light exceeds 30 dB. This means that a noise is occurring in the PSA though the quality of the input signal light into the relay type PSA is improving. This is resulted from the SN ratio of the excitation light not being sufficiently good in comparison with the SN ratio of the signal light. In other words, it means that the characteristics of the low noise property of the PSA cannot be sufficiently obtained unless the SN ratio of the excitation light for causing the PAS to operate is constantly in a better state than the SN ratio of the signal light to be amplified.

On the other hand, when the excitation light is supplied to the PSA by the excitation light generation device of the present disclosure, the noise factor maintains a constant value of 1 dB or more regardless of the value of the SN ratio, until the SN ratio of the input signal light reaches 38 dB. Even if the quality of the input signal light is good, the optical sensitive amplification while maintaining the quality is possible, thus making it possible to confirm that the noise characteristic is significantly improved when the PSA is used as a relay amplifier.

In the above-described disclosure, the example has been described in which the primary sideband light on the high frequency side of the local oscillation light is used to generate the excitation light in the LN modulator. This is because the generation intensity of the primary sideband light is large, which makes it easier to handle. However, as a sideband light, the primary sideband light on the low frequency side may be used, and two or more sideband lights may be used. In addition, a central oscillation frequency of the VCO that supplies the modulation signal to the LN modulator in the OPLL is set to 20 GHz, but the present disclosure is not limited to this.

As described above in detail, when the local oscillation excitation light having a sufficiently high SN ratio using the OPLL is generated by the excitation light generation device of the present disclosure, the inherent low noise operation of the PSA is made possible in the relay type PSA even with respect to the signal light having the high SN ratio. By the excitation light generation device of the present disclosure, it is possible to broaden an application range of the PSA, which is a key to improving the SN ratio necessary for large-capacity optical transmission.

### INDUSTRIAL APPLICABILITY

The present invention can be used for communications. More specifically, it can be used for an optical communication system.

1. A device that generates an excitation light for optical phase sensitive amplification to amplify a signal pair of a signal light and an idler light of the signal light, comprising:
an optical phase lock unit to generate a plurality of sideband lights in synchronization with a phase of the signal pair by an optical phase lock loop (OPLL) with respect to the plurality of sideband lights produced by modulating a local oscillation light; and
an excitation light cut out unit to extract, as an excitation light, one sideband light of the plurality of synchronized sideband lights,
wherein the excitation light cut out unit includes:
a first second-order nonlinear optical element to generate a second harmonic of the local oscillation light;
a phase adjuster to adjust a phase for each sideband light with respect to the plurality of synchronized sideband lights;
a second second-order nonlinear optical element to perform parametric amplification to the phased-adjusted sideband light;
a means to synchronize a phase of the second harmonic and a phase of the one sideband light amplified by the second second-order nonlinear optical element; and
an optical filter to extract only the one sideband light.

2. The device according to claim 1, wherein the phase adjuster is configured to:
set the phase between the one sideband light and the second harmonic such that an amplification operation is performed in the second second-order nonlinear optical element; and
set the phases between other sideband lights excluding the one sideband light as well as the local oscillation light and the second harmonic such that an attenuation operation is performed in the second second-order nonlinear optical element.

3. The device according to claim 1, wherein the optical phase lock unit includes:
a third second-order nonlinear optical element to generate a sum frequency light from the signal pair;
a modulator to produce the plurality of sideband lights by modulating the local oscillation light;
a fourth second-order nonlinear optical element to generate a second harmonic of the sideband light from the modulator;
a phase lock means to detect a phase difference between the one sideband light of the plurality of sideband lights and the sum frequency light and to provide a feedback to the modulator according to the phase difference;
a first splitter to split the local oscillation light at a preceding stage side of the modulator; and
a second splitter to split the plurality of synchronized sideband lights at a subsequent stage side of the modulator.

4. The device according to claim 1, wherein the one sideband light is a primary sideband light on a high frequency side of the local oscillation light.

5. The device according to claim 1, wherein an optical waveguide included in the second-order nonlinear optical element is a directly bonded ridge waveguide,
wherein the directly bonded ridge waveguide is made of any material from among LiNbO₃, KNbO₃, LiTaO₃, LiNb₍ₓ₎Ta₍₁₋ₓ₎O₃(0≤x≤1), and KTiOPO₄, or
a material in which at least one kind selected from a group consisting of Mg, Zn, Sc, and In is added as an additive to any of these materials.

6. A relay type optical amplification device, comprising:
the device according to claim 1; and
a phase sensitive amplifier including:
a fifth second-order nonlinear optical element to generate a second harmonic from the excitation light generated by the excitation light cut out unit;
a sixth second-order nonlinear optical element to perform non-degenerate parametric amplification of the signal pair; and
a phase lock means to synchronize the phase of the signal pair and the phase of the excitation light.

7. The device according to claim 2, wherein the optical phase lock unit includes:
a third second-order nonlinear optical element to generate a sum frequency light from the signal pair;
a modulator to produce the plurality of sideband lights by modulating the local oscillation light;
a fourth second-order nonlinear optical element to generate a second harmonic of the sideband light from the modulator;
a phase lock means to detect a phase difference between the one sideband light of the plurality of sideband lights and the sum frequency light and to provide a feedback to the modulator according to the phase difference;
a first splitter to split the local oscillation light at a preceding stage side of the modulator; and
a second splitter to split the plurality of synchronized sideband lights at a subsequent stage side of the modulator.

8. The device according to claim 2, wherein the one sideband light is a primary sideband light on a high frequency side of the local oscillation light.

9. The device according to claim 3, wherein the one sideband light is a primary sideband light on a high frequency side of the local oscillation light.

10. The device according to claim 2, wherein an optical waveguide included in the second-order nonlinear optical element is a directly bonded ridge waveguide,
wherein the directly bonded ridge waveguide is made of any material from among LiNbO₃, KNbO₃, LiTaO₃, LiNb₍ₓ₎Ta₍₁₋ₓ₎O₃(0≤x≤1), and KTiOPO₄, or
a material in which at least one kind selected from a group consisting of Mg, Zn, Sc, and In is added as an additive to any of these materials.

11. The device according to claim 3, wherein an optical waveguide included in the second-order nonlinear optical element is a directly bonded ridge waveguide,
wherein the directly bonded ridge waveguide is made of any material from among LiNbO₃, KNbO₃, LiTaO₃, LiNb₍ₓ₎Ta₍₁₋ₓ₎O₃(0≤x≤1), and KTiOPO₄, or
a material in which at least one kind selected from a group consisting of Mg, Zn, Sc, and In is added as an additive to any of these materials.

12. The device according to claim 4, wherein an optical waveguide included in the second-order nonlinear optical element is a directly bonded ridge waveguide,
wherein the directly bonded ridge waveguide is made of any material from among LiNbO₃, KNbO₃, LiTaO₃, LiNb₍ₓ₎Ta₍₁₋ₓ₎O₃(0≤x≤1), and KTiOPO₄, or
a material in which at least one kind selected from a group consisting of Mg, Zn, Sc, and In is added as an additive to any of these materials.

13. A relay type optical amplification device, comprising:
the device according to claim 2; and
a phase sensitive amplifier including:
a fifth second-order nonlinear optical element to generate a second harmonic from the excitation light generated by the excitation light cut out unit;
a sixth second-order nonlinear optical element to perform non-degenerate parametric amplification of the signal pair; and
a phase lock means to synchronize the phase of the signal pair and the phase of the excitation light.

14. A relay type optical amplification device, comprising:
the device according to claim 3; and
a phase sensitive amplifier including:
a fifth second-order nonlinear optical element to generate a second harmonic from the excitation light generated by the excitation light cut out unit;
a sixth second-order nonlinear optical element to perform non-degenerate parametric amplification of the signal pair; and
a phase lock means to synchronize the phase of the signal pair and the phase of the excitation light.

15. A relay type optical amplification device, comprising:
the device according to claim 4; and
a phase sensitive amplifier including:
a fifth second-order nonlinear optical element to generate a second harmonic from the excitation light generated by the excitation light cut out unit;
a sixth second-order nonlinear optical element to perform non-degenerate parametric amplification of the signal pair; and
a phase lock means to synchronize the phase of the signal pair and the phase of the excitation light.

16. A relay type optical amplification device, comprising:
the device according to claim 5; and
a phase sensitive amplifier including:
a fifth second-order nonlinear optical element to generate a second harmonic from the excitation light generated by the excitation light cut out unit;
a sixth second-order nonlinear optical element to perform non-degenerate parametric amplification of the signal pair; and
a phase lock means to synchronize the phase of the signal pair and the phase of the excitation light.
